(19) United States
(12) Patent Application Publication
(10) Pub. No.: US 2016/0032637 A1
(43) Pub. Date: Feb. 4, 2016

(54) Car Window Regulator Using Rotational Bearing Pullies

(71) Applicant: A.P.A. Industries, Inc., Simi Valley, CA (US)

(72) Inventor: David K. Johnson, Newbury Park, CA (US)

(73) Assignee: A.P.A. INDUSTRIES, INC., Simi Valley, CA (US)

(21) Appl. No.: 14/450,080

(22) Filed: Aug. 1, 2014

(51) Int. Cl. E05F 11/48; E05F 11/52; B60J 10/04; B60J 1/17; B60J 5/04

(52) U.S. Cl. CPC E05F 11/483; B60J 1/17; B60J 5/0402; B60J 10/042; E05F 11/525

(57) ABSTRACT

In one embodiment, window regulator 140 uses a rotational bearing assembly 270 to reduce stress on the system. The window regulator 140 may guide in a groove 310 a tackle 240 moving a runner 220. The window regulator 140 may move the groove 310 with the tackle 240. The window regulator 140 may rotate the groove 310 around an axis 302 using a rotational bearing assembly 270.

### BACKGROUND

A car window may be raised or lowered to increase air circulation in the car. The height of the car window may be controlled by a window regulator. The window regulator may have a runner supporting the window. The runner may be moved up or down along a regulator track, causing the window to be raised or lowered.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to using a rotational bearing assembly to reduce stress on the system. A window regulator may guide in a groove a tackle moving a runner. The window regulator may move the groove with the tackle. The window regulator may rotate the groove around an axis using a rotational bearing assembly.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a car door.

FIG. 2 illustrates, in a block diagram, one embodiment of a window regulator.

FIGS. 3a-b illustrate, in block diagrams, one embodiment of a ball bearing rotation system.

FIGS. 4a-b illustrate, in block diagrams, one embodiment of a roller bearing rotation system.

FIG. 5 illustrates, in a flowchart, one embodiment of a method of adjusting a window height with a window regulator.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a rotation system, or a window regulator.

A window regulator for an automobile may use a cable and pulley system to move a runner holding a car door window along a track. The pulley for a window regulator provided by the original equipment manufacturer may use a static bearing material to reduce friction between the pulley and the axis. A static bearing material may be poly oxide methylene, or a different lubrication substance that reduces friction with the object with which the static bearing comes into contact. Eventually, the substance may wear out, causing the window regulator to break down. A parts replacement company may manufacture a replacement window regulator to closely match the original. However, replacement window regulators tend to break down even faster.

One problem may be that, while the static bearing reduces friction, friction is not eliminated. The assembly eventually may start to heat up from the friction, causing the pulley to wear or the cable to elongate to the point that the tackle slips the pulley. Static bearings may not reduce friction enough, especially in replacement regulators.

By replacing the static bearing assembly with a rotational bearing assembly, friction may be eased significantly. A rotational bearing places a rotating object, such as a ball bearing or a roller bearing, between an inner section and outer section of the assembly. The rotational bearing assembly places less friction, and thus less wear, on the pulleys and tackle. Additionally, as the cables and pulleys move more freely, the current drain on the motor may be reduced as well, reducing the energy used.

Thus, in one embodiment, window regulator uses a rotational bearing assembly to reduce stress on the system. The window regulator may guide in a groove a tackle moving a runner. The window regulator may move the groove with the tackle. The window regulator may rotate the groove around an axis using a rotational bearing assembly.

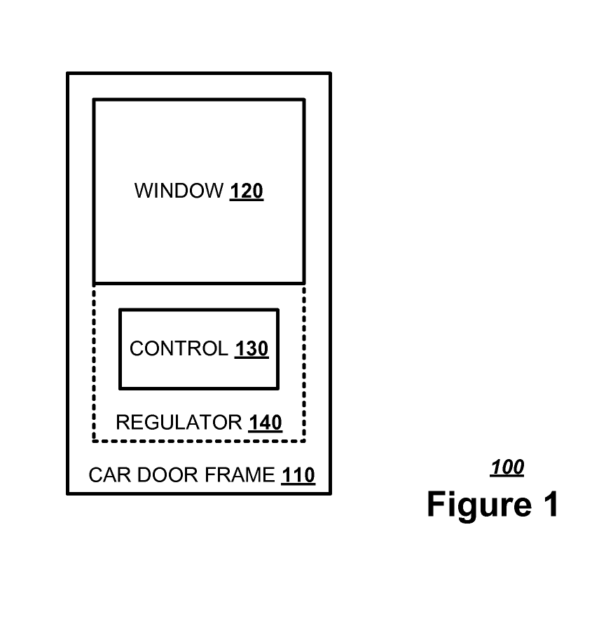

FIG. 1 illustrates, in a block diagram, one embodiment of a car door 100. A car door frame 110 may have a window 120 with an adjustable height to increase air circulation to the car. A window control 130 may allow a driver or a passenger to adjust the height of the window 120. The window control 130 may direct a window regulator 140 inside the car door frame 110 to raise or lower the window 120.

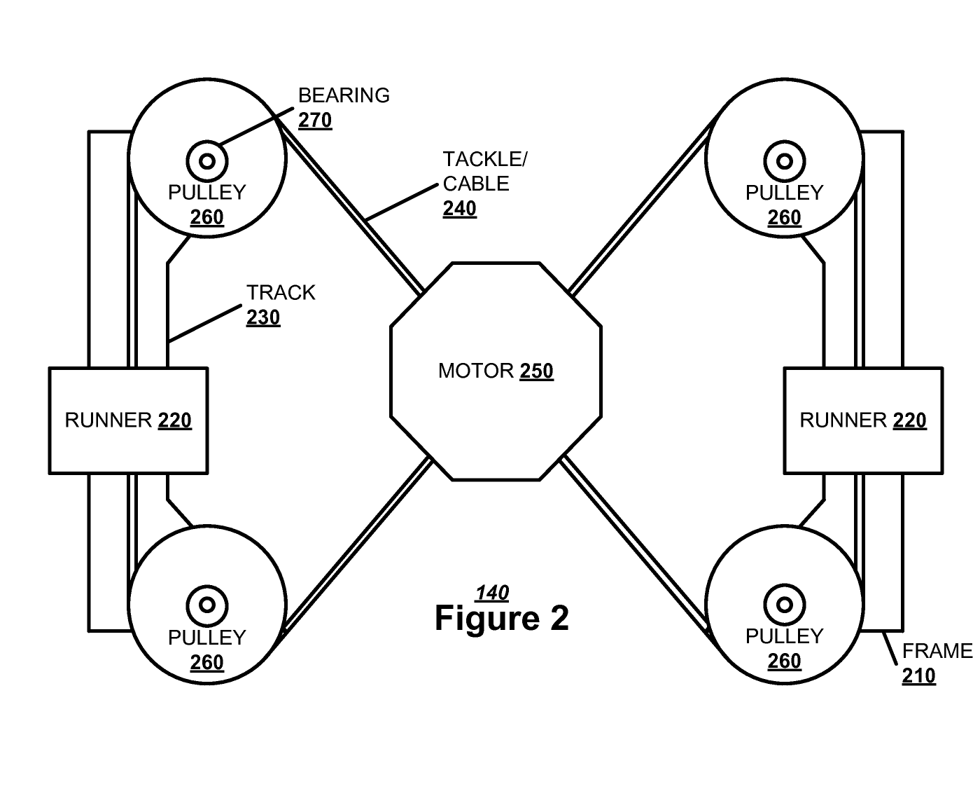

FIG. 2 illustrates, in a block diagram, one embodiment of a window regulator 140. The window regulator 140 may have a regulator frame 210 to support the various window regulator components. A runner 220 may support the window 120 of the car door 100. The runner 220 may move along a regulator track 230 to allow the window 120 to move up and down.

The runner 220 may be moved by a tackle 240, such as a cable 240. The tackle 240 may pull the runner up the regulator track 230 or down the regulator track 230. A motor 250 may move the tackle 240 over a set of one or more pulleys 260. Alternately, a hand crank may allow a driver or passenger to move the tackle 240 over the set of one or more pulleys 260. The pulleys 260 may be made of a static bearing substance, such as poly oxide methylene, to allow the tackle 240 to move more freely over the pulleys 260. Each pulley 260 may rotate around a rotational bearing assembly 270, allowing the pulley 260 to rotate more freely. A rotational bearing assembly 270 is a bearing assembly that uses one or more rolling bearings instead of a static bearing. A rolling bearing is a small circular bearing that rotates interstitially between an inner ring, referred to as an inner race, and an outer ring, referred to as an outer race, in the bearing assembly to ease friction. Alternately, a static bearing does not have an interstitial object rotating between the inner race and the outer race, instead using a lubrication, such as grease or poly oxide methylene material.

By using a rotational bearing assembly 270 to rotate the pulley 260, the amount of friction generated by the pulley is greatly reduced, extending the life of the window regulator 140. Further, the amount of force used to move the tackle 240 on the pulley is greatly reduced. The life of the motor 250 may be increased. The window regulator 140 may use a motor with a smaller current draw. Using a static bearing assembly, a 12 volt motor 250 may have a current draw of 8 amps. With the rotational bearing assembly 270, a 12 volt motor 250 may have a current draw of 4 amps.

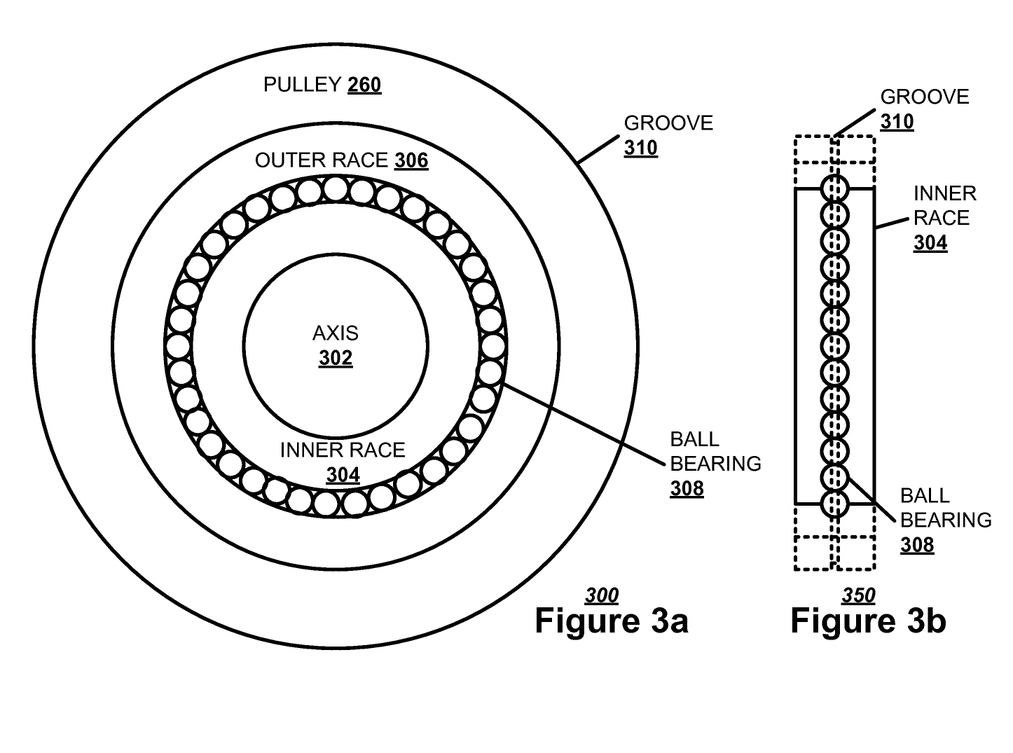

The rotational bearing assembly may use any rotational bearings, such as ball bearings or roller bearings. FIG. 3a illustrates, in a block diagram, a top view 300 of one embodiment of a ball bearing rotation system. The ball bearing rotation system may have a ball bearing assembly that rotates around an axis 302 attached to the regulator frame 210. The ball bearing assembly may have an inner race 304 attached to the axis 302. An outer race 306 may rotate atop ball bearings 308 around the inner race 304. The ball bearing set 308 may interface the inner race 304 with the outer race 306. As shown in the side cutaway view 350 of FIG. 3b, the ball bearings 308 are spherical-shaped bearings that rotate between the inner race 304 and the outer race 306.

The ball bearings 308, inner race 304, and outer race 306 may be made of a hardened substance to prevent them from becoming worn down too quickly. For example, the ball bearings 308, inner race 304, and outer race 306 may be made of carbon steel, chromium steel, graphite, ceramics, or other hardened materials. The ball bearing set 308 may be lubricated to allow for ease of movement. For example, the ball bearing set 308 may be lubricated with molybdenum, lithium, Teflon®, or other lubricants.

The ball bearing rotation system 300 may have a groove 310 for guiding the tackle 240 around the axis 302. The groove 310 may be cut directly on an outer race 306. Alternate the outer race 306 may be attached to a pulley 260 having the groove 310 cut into the outer edge. The pulley 260 may be made of a static bearing substance, such as poly oxide methylene, to allow the tackle 240 to move more freely within the groove 310.

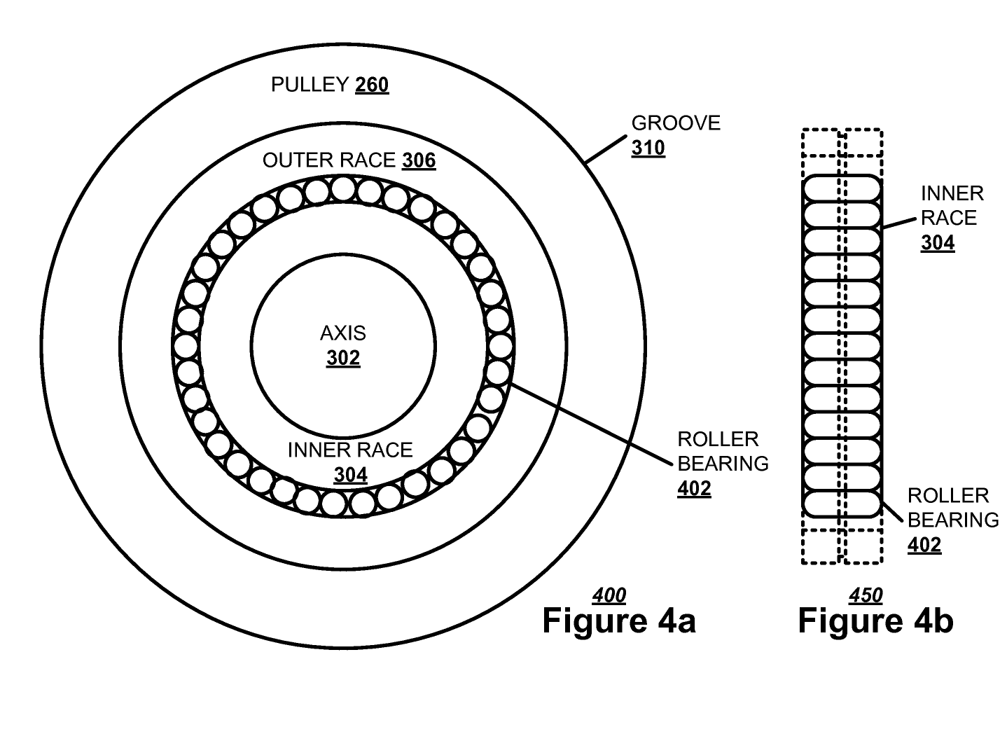

FIG. 4a illustrates, in a block diagram, a top view 400 of one embodiment of a roller bearing rotation system. The roller bearing rotation system may have a roller bearing assembly that rotates around an axis 302 attached to the regulator frame 210. The roller bearing assembly may have an inner race 304 attached to the axis 302. An outer race 306 may rotate atop roller bearings 402 around the inner race 304. The roller bearing set 402 may interface the inner race 304 with the outer race 306. As shown in the side cutaway view 450 of FIG. 4b, the roller bearings 402 are cylindrical-shaped bearings that rotate between the inner race 304 and the outer race 306.

The roller bearings 402, inner race 304, and outer race 306 may be made of a hardened substance to prevent them from becoming worn down too quickly. For example, the roller bearings 402, inner race 304, and outer race 306 may be made of carbon steel, chromium steel, graphite, ceramics, or other hardened materials. The roller bearing set 402 may be lubricated to allow for ease of movement. For example, the roller bearing set 402 may be lubricated with molybdenum, lithium, Teflon®, or other lubricants.

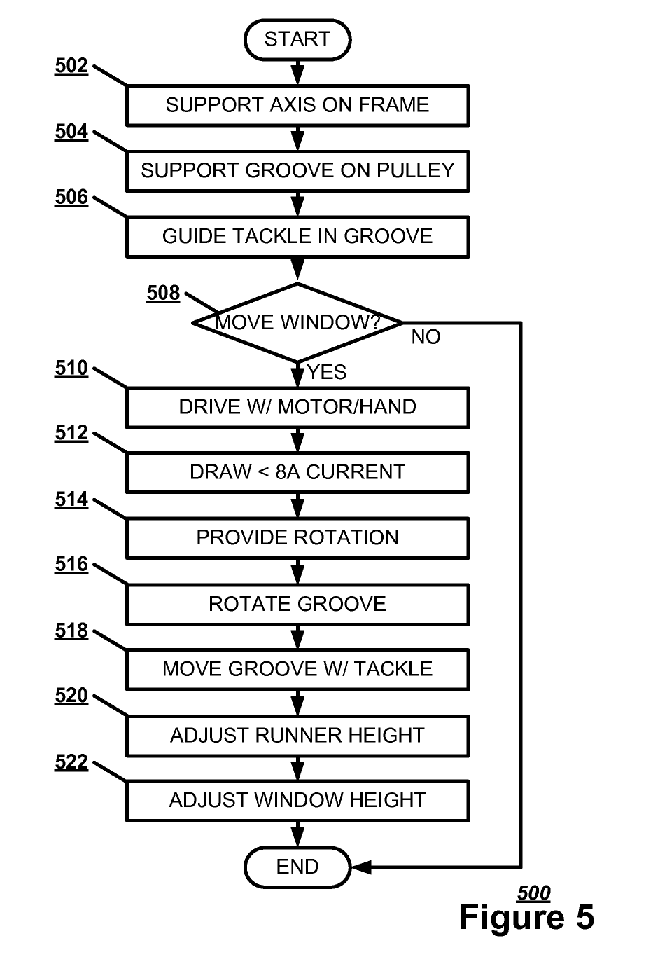

FIG. 5 illustrates, in a flowchart, one embodiment of a method 500 of adjusting a window height with a window regulator 140. The window regulator 140 may support the axis 302 on a regulator frame 210 (Block 502). The window regulator 140 may support a groove 310 on a pulley 260 mounted on a rotational bearing assembly 270 (Block 504). The window regulator 140 may guide in the groove 310 a tackle 240, such as a cable 240, moving a runner 220 (Block 506). If a passenger or driver indicates with the window control 130 to move the window 120 up or down (Block 508), the window regulator 140 may drive the tackle 240 with at least one of a motor 250 or a hand crank (Block 510). The window regulator 140 may draw less than an eight amp current operating the motor (Block 512). The window regulator 140 may provide rotation in the rotational bearing assembly 270 using at least one of ball bearings 308 or roller bearings 402 (Block 514). The window regulator 140 may rotate the groove 310 around the axis 302 using the rotational bearing assembly 270 (Block 516). The window regulator 140 may move the groove 310 with the tackle 240 (Block 518). The window regulator 140 may adjust the runner 220 height along a regulator track 230 (Block 520). The window regulator 140 may adjust a window 120 height with the runner 220 (Block 522).

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A method, comprising:
guiding in a groove a tackle moving a runner for a regulator;
moving the groove with the tackle; and
rotating the groove around an axis using a rotational bearing assembly.

2. The method of claim 1, further comprising:
supporting the groove on a pulley mounted on the rotational bearing assembly.

3. The method of claim 2, wherein the pulley is composed of poly oxide methylene.

4. The method of claim 1, further comprising:
providing rotation in the rotational bearing assembly using at least one of ball bearings and roller bearings.

5. The method of claim 1, further comprising:
supporting the axis on a regulator frame.

6. The method of claim 1, further comprising:
adjusting the runner height along a regulator track.

7. The method of claim 1, further comprising:
adjusting a window height with the runner.

8. The method of claim 1, further comprising:
driving the tackle with at least one of a motor and a hand crank.

9. The method of claim 8, further comprising:
drawing less than an eight amp current operating the motor.

10. The method of claim 1, wherein the tackle is a cable.

11. A rotation system for a regulator, comprising:
a groove that guides a cable moving a runner for a regulator;
a rotational bearing assembly to rotate the groove with the cable; and
an axis to support the rotational bearing assembly.

12. The rotation system of claim 11, further comprising:
a pulley mounted on the rotational bearing assembly that supports the groove.

13. The rotation system of claim 11, wherein the pulley is composed of poly oxide methylene.

14. The rotation system of claim 11, wherein the rotational bearing assembly comprises:
an inner race attached to the axis;
an outer race attached to a pulley supporting the groove; and
a ball bearing set interfacing the inner race with the outer race.

15. The rotation system of claim 11, wherein the rotational bearing assembly comprises:
an inner race attached to the axis;
an outer race attached to a pulley supporting the groove; and
a roller bearing set interfacing the inner race with the outer race.

16. The rotation system of claim 11, wherein the axis is attached to a regulator frame.

17. The rotation system of claim 11, wherein a motor draws less than 8 amps of current driving the cable.

18. A window regulator, comprising:
a window for a door of an automobile;
a runner that moves the window within the door;
a track that guides the runner;
a cable that moves the runner along the track;
a pulley with a groove that guides the cable;
a rotational bearing assembly to rotate the pulley with the cable;
an axis to support the rotational bearing assembly; and
a regulator frame to support the axis.

19. The window regulator of claim 18, further comprising:
a motor drawing less than an eight amp current to drive the cable.

20. The window regulator of claim 18, wherein the pulley is composed of a poly oxide methylene.
